(19) United States
(12) Patent Application Publication
(10) Pub. No.: US 2015/0189101 A1
(43) Pub. Date: Jul. 2, 2015

(54) COMMUNICATION TERMINAL AND METHOD FOR ADJUSTING RINGTONE FOR INCOMING CALL

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: YU TAN, Shenzhen (CN)

(21) Appl. No.: 14/585,364

(22) Filed: Dec. 30, 2014

(30) Foreign Application Priority Data
Dec. 30, 2013 (CN) 201310740720.7

(51) Int. Cl. H04M 19/04

(52) U.S. Cl. CPC H04M 19/042; H04M 19/041

(57) ABSTRACT

A method for adjusting ringtones for incoming calls of a communication terminal provided by the present disclosure includes the following steps. Determine whether the communication terminal stores communication information of the phone number of an incoming call when the communication terminal receives the incoming call. If yes, obtain the times that the phone number has called during a predefined interval from the stored communicated information and determine whether the value of the obtained times that the phone number has called reaches a predefined value. If yes, adjust the ringtone for the incoming call from the phone number. A communicating terminal using the method is also provided.

### CROSS-REFERENCE TO RELATED APPLICATIONS

This application claims priority to Chinese Patent Application No. 201310740720.7 filed on Dec. 30, 2013, the contents of which are incorporated by reference herein.

### FIELD

The subject matter herein generally relates to communication terminals, and particularly to a communication terminal and a method for adjusting ringtone for incoming calls of a communication terminal.

### BACKGROUND

Communication terminals, such as mobile phones, allow users to manually set personalized ringtones for incoming calls. For example, a user can set a ring pattern and a volume for the ringtone of his/her mobile phone, and incoming calls from different contacts may have different ringtones.

### BRIEF DESCRIPTION OF THE DRAWINGS

Implementations of the present technology will now be described, by way of example only, with reference to the attached figures.

FIG. 1 shows a block diagram of a communication terminal in accordance with an exemplary embodiment.

FIG. 2 is a flowchart of an embodiment of a method for adjusting ringtones for incoming calls of a communication terminal, such as the one of FIG. 1.

FIG. 3 is a flowchart of the method for adjusting ringtones for incoming calls of a communication terminal shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module”, “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to a communication terminal and a method for adjusting ringtone for incoming calls of the communication terminal. The method includes the following actions. A processor of the communication terminal determines whether communication data of an incoming call number has been stored in a storage unit of the communication terminal when the communication terminal receives an incoming call from the incoming call number. The processor determines whether call times of the incoming call number during the predetermined time interval reaches a predetermined value according to the communication data of an incoming call number. The processor adjusts a ringtone for the incoming call from the incoming call number if the number of incoming calls during the predetermined time interval reaches the predetermined value.

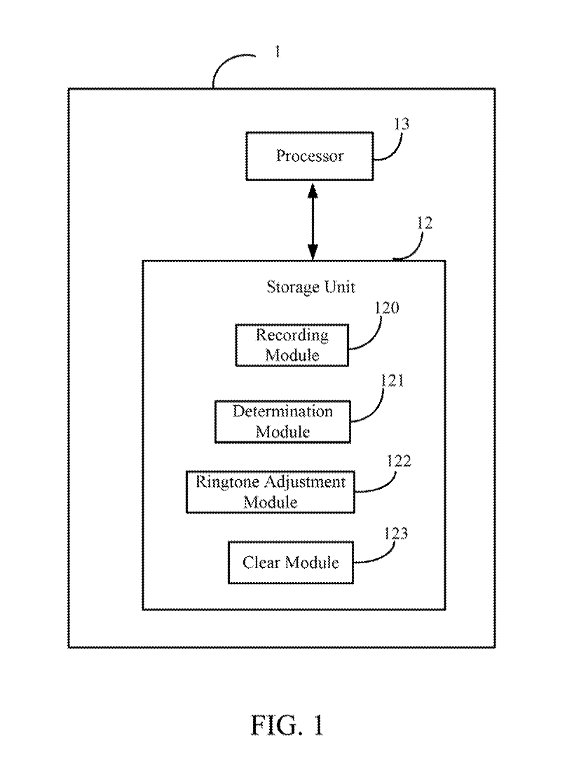

FIG. 1 illustrates a block diagram of an example communication terminal 1 of the present disclosure. In at least one embodiment, the communication terminal 1 has an answering and dialing function, and can be a mobile phone, a telephone, etc.

The communication terminal 1 can include a storage unit 12 and a processor 13. The storage unit 12 can store a predetermined number of incoming calls. In at least one embodiment, there are three predetermined incoming calls; each is different from the other two. For example, a first predetermined value is one, a second predetermined value is three, and a third predetermined value is five. The predetermined number can be predetermined by a system of the communication terminal 1 or preset by a user of the communication terminal 1.

The processor 13 is used to execute applications, such as programs/modules installed in the communication terminal 1, for implementing the method for adjusting ringtones for incoming calls of the communication terminal 1. The storage unit 12 also can store one or more programs, such as the programs installed in the communication terminal 1, for implementing the method for adjusting ringtones for incoming calls of the communication terminal 1 and applications of the communication terminal. The storage unit 12 can be a storage card, such as a memory stick, a smart media card, a compact flash card, a secure digital card, or any other type of memory storage device.

In at least one embodiment, the storage unit 12 can comprise a recording module 120, a determination module 121, and a ringtone adjustment module 122. In alternative embodiments, the storage unit 12 can comprise a clear module 123. The modules 120-123 include computerized code in the form of one or more programs that are stored in the storage unit 12. The computerized code includes instructions that are executed by the processor 13 to provide functions of modules 120-123.

The recording module 120 can be configured for recording communication data of each incoming call number of the communication terminal 1 during each predetermined time interval. In at least one embodiment, the predetermined time interval can be stored in the storage unit 12 and can be a week, a month, or any other period of time. The communication data of each incoming call number can include one or more call time points and associated call duration, call times of the incoming call number. The recording module 120 also can be configured for storing the recorded communication data of each incoming call number in the storage unit 12.

The determination module 121 can be configured for determining whether communication data of an incoming call number has been stored in the storage unit 12 when the communication terminal 1 receives an incoming call from the incoming call number. If yes, the determination module 121 can also determine whether call times of the incoming call number stored in the storage unit 12 reaches one of the predetermined values according to the communication data of an incoming call number.

If the call times of the incoming call number stored in the storage unit 12 during the predetermined time interval reaches one of the predetermined values, the ringtone adjustment module 122 adjusts a ringtone for the incoming call and future incoming calls from the incoming call number during the predetermined time interval. In at least one embodiment, the ringtone adjustment module 122 accordingly controls a volume of the ringtone for the incoming call from the incoming call number. In alternative embodiments, the ringtone adjustment module 122 controls a playing period of the ringtone for the incoming call from the incoming call number.

In at least one embodiment, if the determination module 121 determines the call times of the incoming call number stored in the storage unit 12 when the predetermined time interval reaches the first predetermined value, the ringtone adjustment module 132 controls the volume of the ringtone for the incoming call from the incoming call number to a first predetermined volume. If the determination module 121 determines the number of call times of the number of the incoming calls stored in the storage unit 12 during the predetermined time interval reaches the second predetermined value, the ringtone adjustment module 132 controls the volume of the ringtone for the incoming call from the incoming call number to a second predetermined volume. If the determination module 121 determines the call times of the incoming call number stored in the storage unit 12 during the predetermined time interval reaches the third predetermined value, the ringtone adjustment module 132 controls the volume of the ringtone for the incoming call from the incoming call number to a third predetermined volume. The first, second, and third volumes are higher than a current volume of the communication terminal 1.

In alternative embodiments, if the determination module 121 determines the call times of the incoming call number stored in the storage unit 12 during the predetermined time interval reaches the first predetermined value, the ringtone adjustment module 132 controls a first playing period of the ringtone for the incoming call from the incoming call number to extend (for example 20 seconds). If the determination module 121 determines the call times of the incoming call number stored in the storage unit 12 during the predetermined time interval reaches the second predetermined value, the ringtone adjustment module 132 controls a second playing period of the ringtone for the incoming call from the incoming call number to a second predetermined volume to extend (for example 40 seconds). If the determination module 121 determines the call times of the incoming call number stored in the storage unit 12 during the predetermined time interval reaches the third predetermined value, the ringtone adjustment module 132 controls a third playing period of the ringtone for the incoming call from the incoming call number to a third predetermined volume to extend (for example 60 seconds).

In an embodiment, when a predetermined time interval has passed, the clear module 123 can be configured for clearing communication data of each incoming call number during the predetermined time interval recorded in the storage unit 12. For example, if the predetermined time interval is a week, the recording module 120 records communication data of each incoming call number during the week and stores the recorded data in the storage unit 12.

Then, after that period, the clear module 123 may clear the communication data stored in the storage unit 12 at the beginning of a new week. It is to be understood, a week is a time interval, but can be started from any day of a week (for example Tuesday), and can last for 7 days.

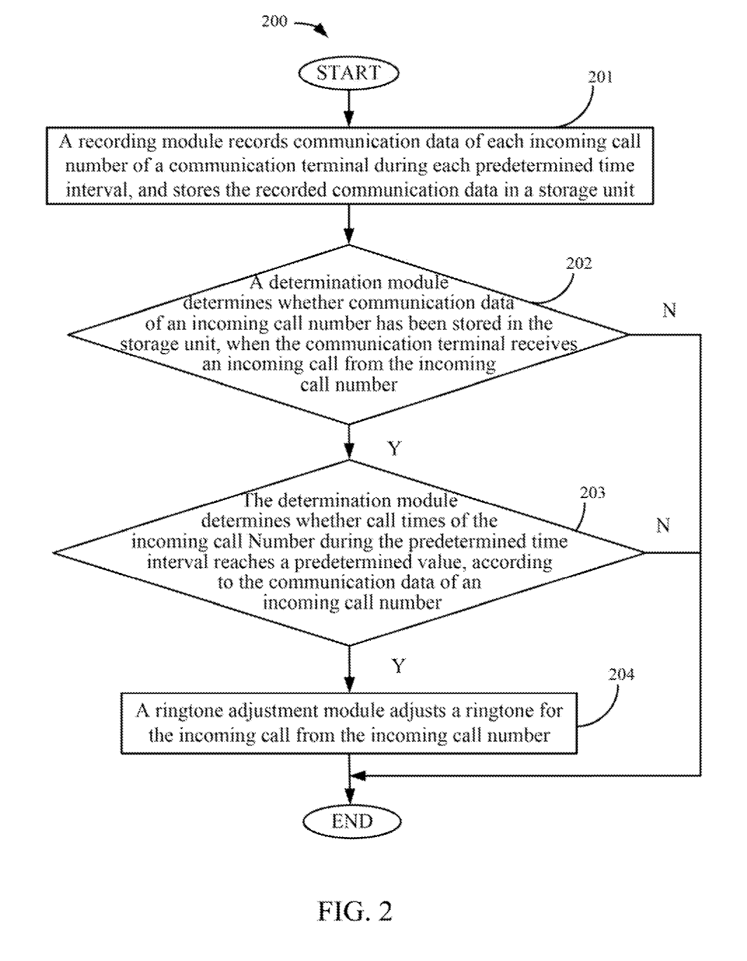

Referring to FIG. 2, a flowchart is presented in accordance with an example embodiment. A method 200 is provided by way of example, as there are a variety of ways to carry out the method. The method 200 described below can be carried out using the configurations illustrated in FIG. 1 and various elements of these figures are referenced in explaining example method 200. Each block shown in FIG. 2 represents one or more processes, methods, or routines, carried out in the exemplary method 200. Additionally, the illustrated order of blocks is by example only and the order of the blocks can be changed. The exemplary method 200 can begin at block 201.

At block 201, a recording module records communication data of each incoming call number of a communication terminal during each predetermined time interval, and stores the recorded communication data in a storage unit. In at least one embodiment, the predetermined time interval can be stored in the storage unit 12 and can be a week, a month, or any other period of time. The communication data of each incoming call number can include one or more call time points and associated call duration, call times of the incoming call number.

At block 202, a determination module determines whether communication data of an incoming call number has been stored in the storage unit when the communication terminal receives an incoming call from the incoming call number. If yes, block 203 is executed. If no, the process ends.

At block 203, the determination module determines whether call times of the incoming call number during the predetermined time interval reaches a predetermined value, according to the communication data of an incoming call number. If yes, block 204 is executed. If no, the process ends.

At block 204, a ringtone adjustment module adjusts a ringtone for the incoming call from the incoming call number. In at least one embodiment, the ringtone adjustment module controls a volume to increase and/or extends a predetermined playing period of the ringtone for the incoming call from the incoming call number. In an alternative embodiment, the ringtone adjustment module adjusts a ringtone for the future incoming calls from the incoming call number.

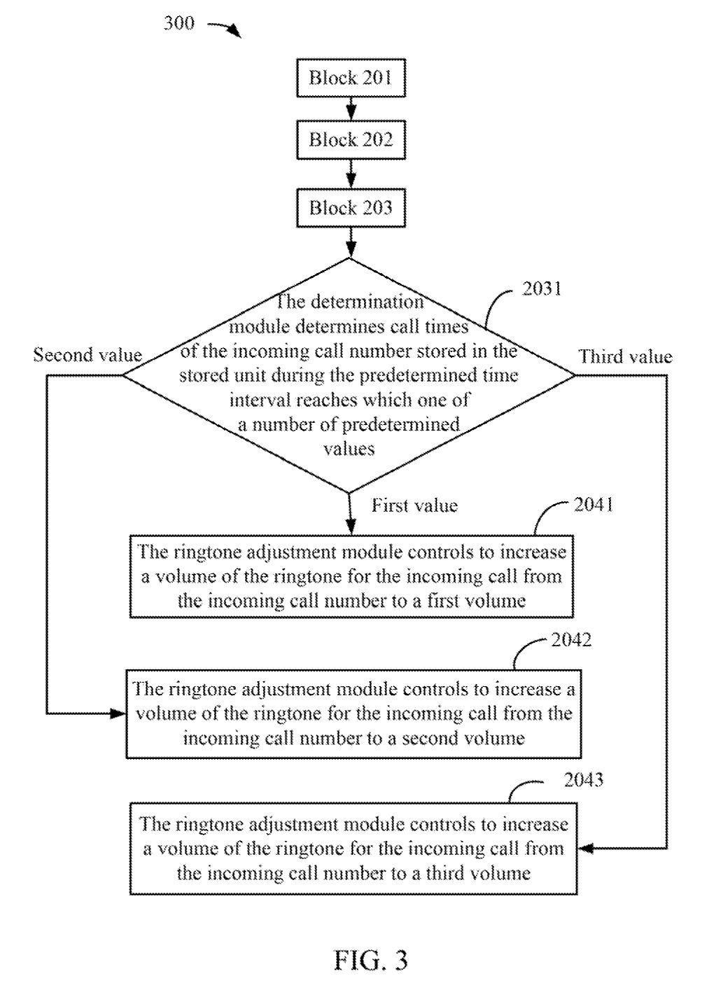

Referring to FIG. 3, a flowchart is presented in accordance with an example embodiment. A method 300 is provided by way of example, as there are a variety of ways to carry out the method. The method 300 described below can be carried out using the configurations illustrated in FIG. 1 and various elements of these figures are referenced in explaining example method 300. Each block shown in FIG. 3 represents one or more processes, methods, or routines, carried out in the exemplary method 300. Additionally, the illustrated order of blocks is by example only and the order of the blocks can be changed. The exemplary method 300 can begin at block 201 and execute block 202 and block 203 as exactly the same shown in FIG. 2. The exemplary method 300 can execute block 2031 after block 203.

At block 2031, the determination module determines that call times of the incoming call stored in the storage unit during the predetermined time interval reaches one of a number of predetermined values. If the determination module determines the call times of the incoming call number stored in the storage unit during the predetermined time interval reaches a first predetermined value, block 2041 is executed. If the determination module determines the call times of the incoming call stored in the storage unit during the predetermined time interval reaches a second predetermined value, block 2042 is executed. If the determination module determines the call times of the incoming call number stored in the storage unit during the predetermined time interval reaches a third predetermined value, block 2043 is executed.

At block 2041, the ringtone adjustment module controls a volume of the ringtone for the incoming call from the incoming call number to increase to a first volume. In alternative embodiments, the ringtone adjustment module also controls a first playing period of the ringtone for the incoming call from the incoming call number to extend.

At block 2042, the ringtone adjustment module controls a volume of the ringtone for the incoming call from the incoming call number to increase to a second volume. In alternative embodiments, the ringtone adjustment module also controls a second playing period of the ringtone for the incoming call from the incoming call number to extend.

At block 2043, the ringtone adjustment module controls a volume of the ringtone for the incoming call from the incoming call number to increase to a third volume. In alternative embodiments, the ringtone adjustment module also controls a third playing period of the ringtone for the incoming call from the incoming call number to extend.

In alternative embodiments, at blocks 2041-2043, the ringtone adjustment module controls a volume of the ringtone for the incoming call from the incoming call number to increase to a corresponding volume, and, at the same time, controls a predetermined playing period of the ringtone for the incoming call from the incoming call number to extend.

The embodiments shown and described above are only examples. Many details are often found in the art such as the other features of a communication terminal and a method for adjusting ringtone for incoming calls of the communication terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A method for adjusting ringtone for incoming calls of a communication terminal, the method comprising:
determining, by a processor of the communication terminal, when the communication terminal receives an incoming call from an incoming call number, whether communication data of the incoming call number has been stored in a storage unit of the communication terminal;
determining, by the processor, according to the communication data of the incoming call number, whether call times of the incoming call number during a predetermined time interval reaches a predetermined value; and
adjusting, by the processor, if the call times of the incoming call number during the predetermined time interval reaches the predetermined value, a ringtone for the incoming call from the incoming call number.

2. The method as claimed in claim 1, wherein adjusting the ringtone comprises:
controlling, by the processor, to increase a volume of the ringtone for the incoming call from the incoming call number.

3. The method as claimed in claim 2, further comprising:
controlling, by the processor, to extend a predetermined playing period of the ringtone for the incoming call from the incoming call number.

4. The method as claimed in claim 1, wherein the predetermined value is selected from the group consisting of a first predetermined value, a second predetermined value, and a third predetermined value; and adjusting the ringtone comprises:
controlling, by the processor, a volume of the ringtone for the incoming call from the incoming call number to increase to a first volume if the call times of the incoming call number during the predetermined time interval reaches a first predetermined value;
controlling, by the processor, a volume of the ringtone for the incoming call from the incoming call number to increase to a second volume if the call times of the incoming call number during the predetermined time interval reaches a second predetermined value; and
controlling, by the processor, a volume of the ringtone for the incoming call from the incoming call number to increase to a third volume if the call times of the incoming call number during the predetermined time interval reaches a third predetermined value.

5. The method as claimed in claim 4, further comprising:
controlling, by the processor, a first playing period of the ringtone for the incoming call from the incoming call number to extend if the call times of the incoming call number during the predetermined time interval reaches a first predetermined value;
controlling, by the processor, a second playing period of the ringtone for the incoming call from the incoming call number to extend if the call times of the incoming call number during the predetermined time interval reaches a second predetermined value; and
controlling, by the processor, a third playing period of the ringtone for the incoming call from the incoming call number to extend if the call times of the incoming call number during the predetermined time interval reaches a third predetermined value.

6. The method as claimed in claim 1, wherein adjusting the ringtone comprises:
controlling, by the processor, a predetermined playing period of the ringtone for the incoming call from the incoming call number to extend.

7. The method as claimed in claim 1, further comprising:
recording communication data of each incoming call number of the communication terminal during each predetermined time interval; and
storing the recorded communication data in the storage unit.

8. A communication terminal comprising:
a storage unit;
a processor, for executing one or more programs stored in the storage unit to:
determine when the communication terminal receives an incoming call from an incoming call number, whether communication data of the incoming call number has been stored in the storage unit,;
determine according to the communication data of an incoming call number, whether call times of the incoming call number during a predetermined time interval reaches a predetermined value; and
adjust a ringtone for the incoming call from the incoming call number, if the call times of the incoming call number during the predetermined time interval reaches the predetermined value.

9. The communication terminal as claimed in claim 8, wherein adjusting a ringtone for the incoming call from the incoming call number comprises:
controlling to increase a volume of the ringtone for the incoming call from the incoming call number.

10. The communication terminal as claimed in claim 8, wherein adjusting a ringtone for the incoming call from the incoming call number comprises:
controlling to extend a predetermined playing period of the ringtone for the incoming call from the incoming call number.

11. The communication terminal as claimed in claim 8, wherein adjusting a ringtone for the incoming call from the incoming call number comprises:
controlling to increase a volume of the ringtone and extend a predetermined playing period of the ringtone for the incoming call from the incoming call number.

12. The communication terminal as claimed in claim 8, wherein the predetermined value is selected from the group consisting of a first predetermined value, a second predetermined value, and a third predetermined value; and adjusting a ringtone for the incoming call from the incoming call number comprises:
controlling a volume of the ringtone for the incoming call from the incoming call number to increase to a first volume if the call times of the incoming call number during the predetermined time interval reaches a first predetermined value;
controlling a volume of the ringtone for the incoming call from the incoming call number to increase to a second volume if the call times of the incoming call number during the predetermined time interval reaches a second predetermined value; and
controlling a volume of the ringtone for the incoming call from the incoming call number to increase to a third volume if the call times of the incoming call number during the predetermined time interval reaches a third predetermined value.

13. The communication terminal as claimed in claim 12, wherein adjusting a ringtone for the incoming call from the incoming call number further comprises:
controlling a first playing period of the ringtone for the incoming call from the incoming call number to extend if the call times of the incoming call number during the predetermined time interval reaches a first predetermined value;
controlling a second playing period of the ringtone for the incoming call from the incoming call number to extend if the call times of the incoming call number during the predetermined time interval reaches a second predetermined value; and
controlling a third playing period of the ringtone for the incoming call from the incoming call number to extend if the call times of the incoming call number during the predetermined time interval reaches a third predetermined value.

14. The communication terminal as claimed in claim 8, wherein the processor is also configured for executing one or more programs stored in the storage unit to:
record communication data of each incoming call number of the communication terminal during each predetermined time interval; and
store the recorded communication data in the storage unit.
